(19) United States
(12) Patent Application Publication
(10) Pub. No.: US 2025/0200356 A1
(43) Pub. Date: Jun. 19, 2025

(54) AUTOMATED LABEL GENERATION USING A MACHINE-LEARNED LANGUAGE MODEL

(71) Applicant: Maplebear Inc., San Francisco, CA (US)

(72) Inventors: Xuan Zhang, Palo Alto, CA (US); Tejaswi Tenneti, San Carlos, CA (US); Haixun Wang, Bellevue, WA (US)

(21) Appl. No.: 18/542,375

(22) Filed: Dec. 15, 2023

(51) Int. Cl. G06N 3/08

(52) U.S. Cl. CPC G06N 3/08

(57) ABSTRACT

An online system may provide an instruction prompt to a machine-learned language model. The instruction prompt may include an instruction to generate an evaluation label of a training sample of a classification model and a textual format related to how data is arranged. The evaluation label may be used in a supervised training of the classification model. The online system may provide a batch of evaluation request prompts to the machine-learned language model. Each evaluation request prompt includes data that is at least partially arranged in the textual format described in the instruction prompt. The online system may receive a plurality of responses from the machine-learned language model. Each response includes the evaluation label corresponding to each evaluation request prompt. The online system may store at least evaluation labels and the data in the evaluation request prompts as training samples for the supervised training of the classification model.

### BACKGROUND

In the development of artificial intelligence such as supervised machine learning, high-quality ground truth data often significantly impacts the performance of training and evaluating models. Conventionally, the acquisition of such data has been reliant on the construction of exhaustive guidelines and the engagement of manual labor tasked with analyzing data and providing labels. This manual approach is inefficient, time-intensive, and costly due to the human labor integral to the process.

### SUMMARY

A machine-learned language model is often a large and complex artificial intelligence model that could include billions of parameters. Because of the complexity of the language model, it is often a non-trivial and sometimes difficult task to determine what the best practice is to create a prompt to provide instructions or questions to a language model so that the language model provides a response that is most relevant and direct to the prompt. In one or more embodiments, an online system may provide an instruction prompt that includes chain-of-thoughts instructions and examples for the machine-learned language model to follow and automatically generate labels based on the data provided to the language model.

By way of example, in one or more embodiments, an online system may provide an instruction prompt to a machine-learned language model. The instruction prompt may include an instruction to generate an evaluation label of a training sample of a classification model and a textual format related to how data is arranged. The evaluation label may be used in a supervised training of the classification model. The online system may provide a batch of evaluation request prompts to the machine-learned language model. Each evaluation request prompt includes data that is at least partially arranged in the textual format described in the instruction prompt. The online system may receive a plurality of responses from the machine-learned language model. Each response includes the evaluation label corresponding to each evaluation request prompt. The online system may store at least evaluation labels and the data in the evaluation request prompts as training samples for the supervised training of the classification model.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 is a flowchart for a process for generating automatic evaluation labels by a machine-learning language model that evaluates the results of a classification model, in accordance with some embodiments.

FIG. 4 is a conceptual diagram illustrating the textual format of an instruction prompt 400, in accordance with some embodiments.

FIG. 5 is a flowchart for a process for training a classification model, in accordance with some embodiments.

FIG. 6 is a flowchart for a process for categorizing a query result, in accordance with some embodiments.

FIG. 7 is a flowchart for a process for presenting sponsored items, in accordance with some embodiments.

FIG. 8 is an example structure of a classification model, in accordance with some embodiments.

### DETAILED DESCRIPTION

### System Environment

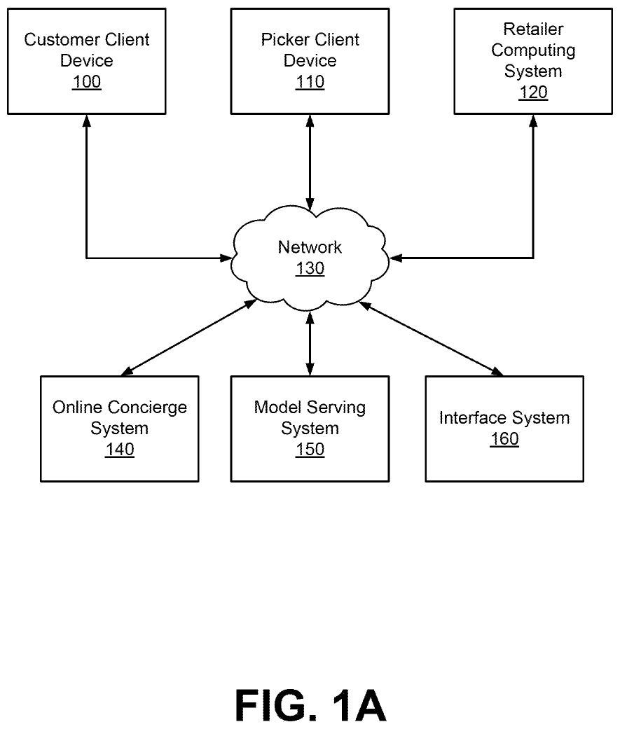

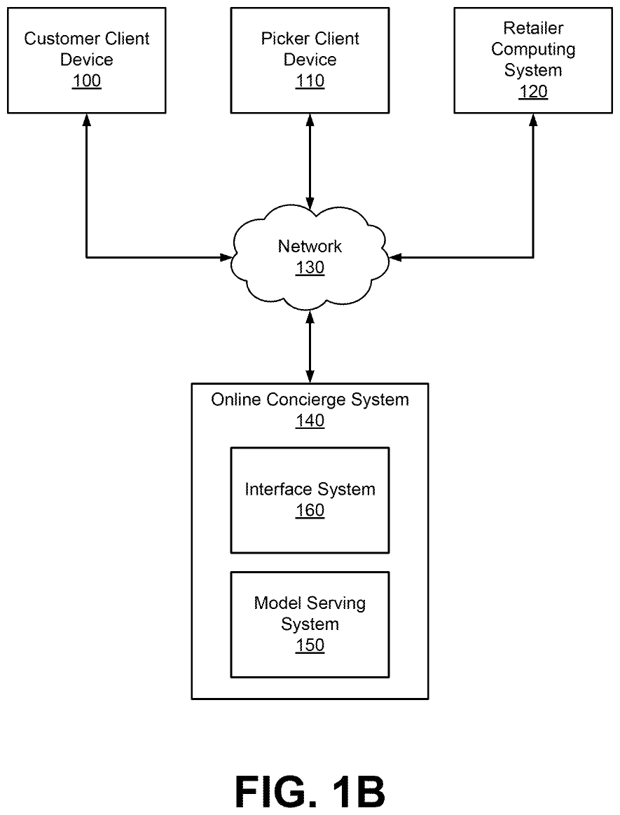

FIG. 1A illustrates an example system environment for an online concierge system 140, in accordance with one or more embodiments. The system environment illustrated in FIG. 1A includes a customer client device 100, a picker client device 110, a retailer computing system 120, a network 130, and an online concierge system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines the weights for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role of a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

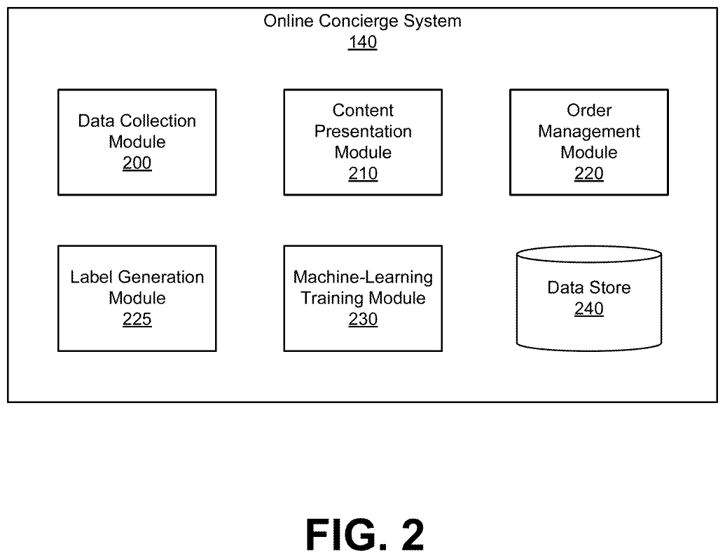

As an example, the online concierge system 140 may allow a customer to order groceries from a grocery store retailer. The customer's order may specify which groceries they want to be delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens is arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has a significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online concierge system 140 performs automatic label assignments for data using a machine-learned language model. The machine-learned language model may be used to automatically generate evaluation labels for outputs of the online concierge system 140. In some embodiments, the online concierge system 140 may provide a detailed instruction prompt that includes chain-of-thoughts instructions and examples of the machine-learned language model. In turn, a large number of data samples may be supplied to the machine-learned language model in batches and the machine-learned language model provides evaluations based on the criteria set by the instruction prompt. The labels may be used for item categorization, supervised training of a machine learning model, and other uses.

In one or more embodiments, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online concierge system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data sources.

In one or more embodiments, the online concierge system 140 performs automated label generation using a machine-learned language model. Specifically, the online concierge system 140 provides training samples to be labeled to the interface system 160. The online concierge system 140 provides a query to the interface system 160. The online concierge system 140 receives a response to the prompt from the interface system 160 based on the execution of the machine-learned model in the model serving system 150 using prompts generated by the interface system 160. The online concierge system 140 obtains the responses which contain labels of the training samples in a large batch.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140.

FIG. 2 illustrates an example system architecture for an online concierge system 140, in accordance with some embodiments. The system architecture illustrated in FIG. 2 includes a data collection module 200, a content presentation module 210, an order management module 220, a label generation module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describes characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or may be replacements for each other in a purchase order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has service orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine the likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on the relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on the predicted availability of an item. The content presentation module 210 may use an availability model to predict the availability of an item. An availability model is a machine learning model that is trained to predict the availability of an item at a retailer location. For example, the availability model may be trained to predict the likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes the total cost for the order and charges the customer that cost. The order management module 220 may provide a portion of the total cost to the picker for servicing the order, and another portion of the total cost to the retailer.

The label generation module 225 may be used to automatically generate evaluation labels for outputs of one or more modules of the online concierge system 140. The label generation process is further described in the process 300 and includes the use of a machine-learned language model to automatically analyze data and assign evaluation labels. In some embodiments, the online concierge system 140 may provide a detailed instruction prompt that includes chain-of-thoughts instructions and examples of the machine-learned language model. In turn, a large number of data samples may be supplied to the machine-learned language model in batches and the machine-learned language model provides evaluations based on the criteria set by the instruction prompt. The labels generated may have different uses that are discussed in the processes 500, 600, and 700.

The machine learning training module 230 trains machine learning models used by the online concierge system 140. For example, the machine learning module 230 may train the item selection model, the availability model, or any of the machine-learned models deployed by the model serving system 150. The online concierge system 140 may use machine learning models to perform the functionalities described herein. Example machine learning models include regression models, support vector machines, naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied to each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label that represents an expected output of the machine learning model. In these cases, the machine learning model is trained by comparing its output from the input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online concierge system 140. In one or more embodiments, when the model serving system 150 is included in the online concierge system 140, the machine-learning training module 230 may further train parameters of the machine-learned model based on data specific to the online concierge system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### Automatic Label Generation Using a Language Model

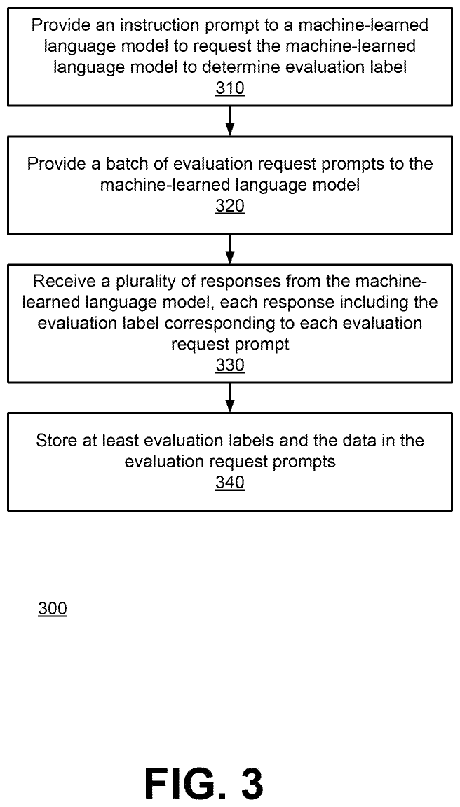

FIG. 3 is a flowchart for a process 300 for generating automatic evaluation labels by a machine-learning language model that evaluates the results of a classification model, in accordance with some embodiments. Alternative embodiments may include more, fewer, or different steps from those illustrated in FIG. 3, and the steps may be performed in a different order from that illustrated in FIG. 3. These steps may be performed by an online system (e.g., online concierge system 140). Additionally, each of these steps may be performed automatically by the online concierge system without human intervention.

In some embodiments, the online system provides 310 an instruction prompt to a machine-learned language model. The machine-learned language model can be any language model provided by the model serving system 150. The instruction prompt provides an instruction for the machine-learned language model to generate evaluation labels for the outputs of a classification model. The classification model is another machine-learned model that may have been trained or untrained. The online system collects outputs generated by the classification model and instructs the machine-learned language model to evaluate the outputs based on both the inputs and the outputs of the classification model. The evaluation results may take the form of evaluation labels that can serve different purposes. For example, the evaluation labels may serve as the training labels for the classification model to be trained or further trained in supervised training.

A classification model discussed in this disclosure may be any type of suitable machine learning model, such as a binary classifier, a multi-label classifier, a regression model, a score generation model, a Bayesian model, a probabilistic model, etc. For example, the classification model may be an item query engine or a search query engine that identifies an output based on a user query. While the model is referred to as performing classification, the classification task does not need to necessarily mean putting something into one or more categories. The classification performed may also be in the form of generating a score that signifies a meaning or selecting an item or a concept based on an input. In some embodiments, the classification model may also simply be referred to as a machine-learned model and may also be a second machine-learned language model different from the first machine-learned language model that is used to generate evaluation labels.

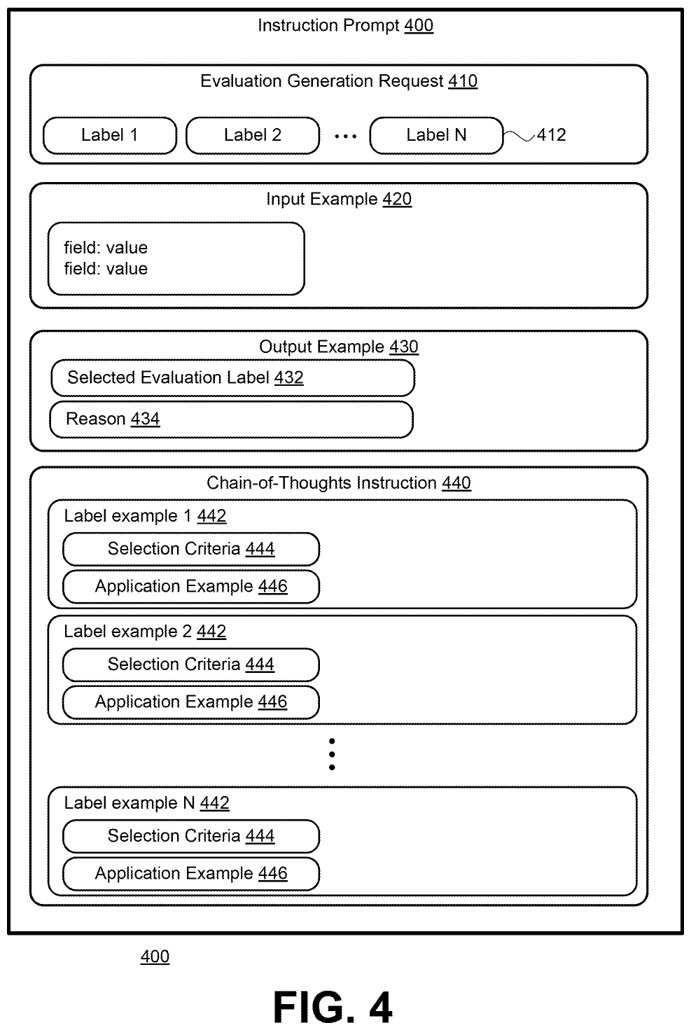

In various embodiments, the instruction prompt includes different components. Prompt engineering techniques may be used to refine the instruction prompt to improve the performance of the machine-learned language model. The components in the instruction prompt may include instructions, examples, chain-of-thoughts, formatting, data types, attribute descriptions, context, control codes or tokens, prefix tuning, rules, constraints, evaluation, validation, and other suitable specifications for the analysis process and outputs of the machine-learned language model. In some embodiments, the instruction prompt includes a textual format related to how data is arranged to allow the machine-learned language model to understand how the data should be analyzed. In some embodiments, the instruction prompt includes chain-of-thoughts examples to teach the machine-learned language model how to analyze data. Various examples of components of an instruction prompt are further discussed in FIG. 4.

In some embodiments, through the instruction prompt, the online system specifies an input textual format of the input that the machine-learned language model is to receive. For example, the instruction prompt may include the data fields in the upcoming inputs to the machine-learned language model. The online system also specifies an output textual format of the output that the machine-learned language model is to generate. For example, the output textual format may specify that the output should include the evaluation label and the reasoning of the machine-learned language model assigning such a label. The online system may include a chain-of-thoughts instruction for the machine-learned language model to follow in performing evaluation. For example, the chain-of-thoughts instruction includes an explanation of how an input should be classified to an evaluation label. The chain-of-thoughts instruction may include an explanation for each of the evaluation labels.

In some embodiments, through the instruction prompt, the online system specifies the input and output formats to be provided to the machine-learned language model. For example, the online system may provide a multimodal input example that follows a textual format. The multimodal input example may take the form of a composite example of different textual fields. The textual fields may include an input that was provided to the classification model, an output that was generated by the classification model, attribute data retrieved from a database of the online system, and/or an image. Using an item query classification model as an example, a multimodal input example may include the user query that searches for items, the item found and displayed to the users, metadata, and attributes of the item, and an image of the item. The instruction prompt instructs the machine-learned language model to evaluate the quality of the query result relative to the query (e.g., how the found item matches the user input query). With respect to the output, the online system may specify an output format that includes the evaluation label and a reason for assigning the evaluation label. For example, in the context of the item query classification model, the evaluation label may be the extent to which the found item matches the user input query. The output of the machine-learned language model may also include the reasoning of the machine-learned language model assigning such a label.

While in this disclosure an item query classification model is used as a primary example of a classification model, various processes and techniques disclosed herein for using a machine-learned language model to generate evaluation labels can be applied to any type of machine-learned models, including the item query classification model and another supervised learning model.

In some embodiments, the online system specifies a set of candidate evaluation labels in the instruction for the machine-learned language model to generate the evaluation label. The candidate evaluation labels are choices that the machine-learned language model may use as the output of the evaluation result. In some embodiments, the set of candidate evaluation labels may correspond to the output categories of the classification model. For example, the classification model is trained using training samples that have a range of labels. The range of labels is also used as the set of candidate evaluation labels for the machine-learned language model so that the evaluation labels can be used directly as training labels of the classification model. For example, in the context of an item query classification model, the set of candidate evaluation labels may include exact, substitute, complement, irrelevant, and unjudgeable.

In some embodiments, through the instruction prompt, the online system provides an example for each candidate evaluation label on one or more selection criteria for the candidate evaluation label. The online system provides a chain-of-thoughts instruction in applying one or more selection criteria for each candidate evaluation label. For example, the instruction prompt may explain the selection criteria and how the criteria are applied to the data to be provided to the machine-learned language model. In some embodiments, the instruction prompt also includes a chain-of-thoughts example explaining why an input to the machine-learned language model should or should not be assigned with a particular candidate evaluation label.

In some embodiments, through the instruction prompts, the online system provides context-specific instructions for the machine-learned language model to perform the evaluation. Using the item query classification model as an example, which is a search engine for an item based on a search query. The online system may include a first instruction for the machine-learned language model to identify a search intent from the search query. The online system may include a second instruction for the machine-learned language model to identify one or more attributes of the item returned by the search engine. The online system may provide one or more examples of the machine-learned language model on how the evaluation label is assigned based on comparing one or more attributes of the item to the search intent.

In some embodiments, the online system provides 320 a batch of evaluation request prompts to the machine-learned language model. By providing the machine-learned language model in a batch, the machine-learned language model can automatically mass produce labeled data such as training samples for a classification model for supervised learning. This reduces the manual work that needs to be performed to generate labels for data. This also increases the accuracy of the conventional method or other machine labeled method because the machine-learned language model is required to provide an explanation of the assignment. In various embodiments, the batch of evaluation request prompts may take different forms. For example, each evaluation request may be a single message to the machine-learned language model. The message includes the data for a sample. As such, the online system sends a series of messages to the machine-learned language model for the machine-learned language model to generate a response to each message. Each response generated by the machine-learned language model may include the evaluation label for the particular sample and the reason the evaluation label is assigned by the machine-learned language model. In one or more embodiments, the batch of evaluation request prompts may be packaged into a single message or a few messages to be sent to the machine-learned language model. Various other ways to combine or separate the evaluation request prompts may also be possible.

In some embodiments, the online system may create a batch of evaluation request prompts by retrieving stored outputs of the classification model. The stored outputs may be referred to as historical data of the classification model. For example, the classification model may be preliminarily trained or may be based on other rule-based algorithms to generate outputs based on end users' inputs. The input-output pairs are stored in a database for further evaluation of the performance of the classification model. The online system retrieves historical inputs and historical outputs of the classification model that are stored in the database. The online system may format the historical inputs and historical outputs according to the textual format that is provided in the instruction prompt. For example, the online system may also retrieve multi-modal data and/or out-of-band information to complement the stored inputs and outputs of the classification model. For example, the online system may retrieve an image that is associated with an item or a concept in the input or output. The online system may also retrieve metadata, descriptions, and other attributes associated with any items or concepts in the input or output. The online system may retrieve a large number of historical input-output pairs and associated additional data. The online system may format the historical input-output pairs and associated additional data in the textual structure specified in the instruction prompt. In turn, the online system generates the batch of evaluation request prompts.

In various embodiments, the precise format and content of each evaluation request prompt may take any suitable form. In some embodiments, even though the prompt is referred to as an evaluation request prompt, the actual content of the prompt does not need to include any request. For example, the request may be sufficiently specified in the instruction prompt and the evaluation request prompt may include solely the input-output pairs and associated additional data. In other embodiments, an evaluation request prompt may include simple instructions such as “please assign the evaluation label based on my instructions in the instruction prompt” followed by the data. In some embodiments, each evaluation request prompt may include data that is at least partially arranged in the textual format described in the instruction prompt. For example, the instruction prompt may include an example of the evaluation request prompt that is organized in fields or key-value pairs. The actual evaluation request prompts may follow strictly or partially the format provided in the instruction prompt.

In some embodiments, the online system receives 330 a plurality of responses from the machine-learned language model. In response to receiving the batch of evaluation request prompts, the machine-learned language model provides the responses. Each response includes the evaluation label corresponding to the data in an evaluation request prompt. The response may include other things, such as reasoning of the evaluation label, metadata, and other relevant information that is requested in the instruction prompt. The plurality of responses may be sent as a plurality of messages or one or more combined messages from the machine-learned language model.

In some embodiments, the online system stores 340 at least evaluation labels and the data in the evaluation request prompts as training samples for the supervised training of the classification model. For example, the online system may format the response from the machine-learned language model and the sample data as training samples. The training samples may be packaged as feature vectors that include attributes, historical inputs and historical outputs as one or more features and the evaluation label as the training sample. In some embodiments, instead of storing the data as training samples for a classification model, the online system may also store the evaluation label as one of the metadata fields in a data store.

In some embodiments, the online system uses the training samples to train or re-train the classification model using a supervised learning technique. The online system retrieves the training samples of the classification model. The training samples each include the evaluation label generated by the machine-learned language model as the training label. The online system applies, in forward propagation, the classification model to the training samples to generate predicted labels. The online system compares the predicted labels to the evaluation label generated by the machine-learned language model. The online system adjusts, in backpropagation, one or more parameters of the machine-learned language model based on the comparison.

In some embodiments, the online system uses the evaluation labels outputted by the machine-learned language model to classify an item for an item query engine, which is an example of a classification model. The online system receives a query from the query engine. The online system identifies, by the classification model, an item based on the query. The online system applies the machine-learned language model to generate the evaluation label for the item. The labels may be exact, substitute, complement, irrelevant, unjudgeable, or another suitable evaluation of the relationship between the input query and the output item. The online system provides the evaluation label as a classification in response to the query. For example, the online system may provide a list of items that match the query. The items may be further categorized based on the evaluation labels such as an exact match to the criteria in the query, a substitute to the item asked in the query, a complement item for the item searched in the query, etc.

In some embodiments, the online system may use the evaluation labels outputted by the machine-learned language model to select the content item, such as a sponsored content item, for display to a user based on a query of the user. The classification model in this example may take the form of an item query engine. The online system receives a query for the item query engine. The online system identifies, by the item query engine, a plurality of items based on the query. The online system applies the machine-learned language model to generate evaluation labels for the plurality of items. The online system selects, based on the evaluation labels, one of the plurality of items as a sponsored item to be displayed as a response to the query. For example, the online system may determine, based on the evaluation label, that a sponsored item is a substitute for the item specified in the user query. The online system may present the sponsored item and promote it as a substitute. In another example, the online system may determine, based on the evaluation label, that another sponsored item is a complement to the item specified in the user query. In response, the online system may present the sponsored item and recommend it as something that should be purchased together with the items displayed in the query result.

### Example Instruction Prompt

FIG. 4 is a conceptual diagram illustrating the textual format of an instruction prompt 400, in accordance with some embodiments. The format and components of the instruction prompt 400 illustrated in FIG. 4 are exemplary only. In various embodiments, the instruction prompt 400 may include fewer, additional, or different components. The order, components, and formats in instruction prompt 400 may also be changed in other embodiments. The components in the instruction prompt 400 will be discussed using the context of an item query classification model as an example. In various embodiments, the components, precise instructions, textual format, and data fields in the instruction prompt 400 may be changed based on the type of classification model.

The instruction prompt may include an evaluation generation request 410 that may specify a set of candidate evaluation labels 412, an input example 420 of the machine-learned language model, an output example 430 of the machine-learned language model, a chain-of-thoughts instruction 440 that includes an explanation for selecting one or more candidate evaluation labels 412. In some embodiments, the chain-of-thoughts instruction 440 may include a plurality of label examples 442 that provides selection criteria 444 for a particular candidate evaluation label 412 and an application example 446 for how the selection criteria 444 are applied.

An evaluation generation request 410 may provide the general instruction and background information for the machine-learned language model to understand the evaluation task to be performed. The evaluation generation request 410 may include an instruction on what kinds of outputs the machine-learned language model will need to generate. The evaluation generation request 410 may also specify the set of candidate evaluation labels 412 that the machine-learned language model is allowed to choose. For example, in the context of an item query engine, the evaluation generation request 410 may include an introduction regarding what the item query engine does and the inputs and outputs that are typically generated by the item query engine. The evaluation generation request 410 may also specify that the output of the item query engine may include items and item images. The evaluation generation request 410 may further include an instruction that defines the set of candidate evaluation labels 412, such as an instruction, “classify the relationship between the term and the product into 5 categories: exact, substitute, complement, irrelevant, unjudgeable.”

In some embodiments, the input example 420 includes an actual example of the evaluation request prompt to be received by the machine-learned language model. Note that the input example 420 may be the input of the machine-learned language model instead of the input of the classification model. The input example 420 may be in a specific textual format such as a set of data that includes various fields. The fields may include the historical input and historical output of the classification model, one or more attributes related to the historical input-output pairs, and one or more relevant images. An example of the input example 420 is shown below.
Search term: apple pie
Product image: https://abcd.net/product-image/file/1.jpg
Product name: Mrs. Smith's Original Flaky Crust Apple Pie Product description: No artificial sweeteners. No artificial dyes. No high fructose corn syrup. Since 1919. Just like homemade. Our pies do not contain: High fructose corn syrup. Artificial sweeteners or dyes. Nothing creates a delicious, warm welcome like Mrs. Smith's blue ribbon pies. Lovingly made from Amanda Smith's original recipes created in the early 1900s, only Mrs. Smith's pies have her signature blue ribbon award-winning flaky crust, made with a touch of real sweet cream butter, abundant seasonal fruit, and signature spices. Today, our bakers spend hours delicately preparing each pie, and personally sample a handful each day to ensure that each and every pie tastes as good as the original. So when you serve up a slice of Mrs. Smith's blue ribbon apple pie, you can be sure your guests will feel welcome with every bite. Sustainable Forestry Initiative: Certified chain of custody. Promoting sustainable forestry.
Category: Food>Frozen Food>Frozen Desserts>Frozen Pies

The output example 430 may include an actual example of the output to be generated by the machine-learned language model in response to receiving an evaluation request prompt. Similar to the input example 420, the output example 430 may be the output of the machine-learned language model instead of the output of the classification model. In output example 430 may also be in a specific textual format that includes the selected evaluation label 432 and the reasoning 434 of the selection. Other output fields are also possible and may be specified in the evaluation generation request 410 and/or the output example 430. An example of the output example 430 is shown below.
Class: Exact
Reason: The product exactly matches the search intent and meets the attribute specified (apple, not pear pie).

The chain-of-thoughts instruction 440 is a series of step-by-step instructions for the machine-learned language model to follow to analyze the data and generate an evaluation. The chain-of-thoughts instruction 440 may define concepts, distinguish types of attributes, provide selection criteria, and explain the application of selection criteria through one or more examples. In some embodiments, the chain-of-thoughts instruction 440 may go through each of the candidate evaluation labels 412 to provide detailed instructions to the machine-learned language model on how to assign the evaluation label.

In the context of an item query engine, the chain-of-thoughts instruction 440 may start with an introduction of different concepts, such as identifying the core product concept, the search intent, and the attributes in the search term and product. For example, the chain-of-thoughts instruction 440 may define that the core product concept refers to the main product that a user is looking for. The chain-of-thoughts instruction 440 may also define that attribute refers to any feature that describes or refines the product (e.g., brand, size, flavor, dietary preference/restriction, etc.). The chain-of-thoughts instruction 440 may provide an example of those definitions of concepts.
For example, for the term “2% organic milk”, the core product concept is milk, “2%” and “organic” are attributes.

The chain-of-thoughts instruction 440 may also include a series of label examples 442. Each label example 442 goes through the selection criteria 444 for assigning a particular candidate evaluation label 412 and an application example 446 of how the selection criteria 444 should be applied. For instance, for the candidate evaluation label 412 “exact,” the selection criteria 444 may include a criterion that such label should be applied if the item found fully satisfies the search intent. Another selection criterion 444 may be that the machine-learned language model is required to assign the “exact” label only if both the core product concept and all specified attributes meet the conditions specified in the search term.

In some embodiments, the chain-of-thoughts instruction 440 may provide multiple application examples 446 to the “exact” label. For example, the following two application examples 446 may be used.
When the search term is more specific, only products that fully meet all specified attributes in the search term can be Exact. For example,
Search term: ABC strawberry ice cream
Product name: ABC Oregon Strawberry Ice Cream Sandwich
Class: Exact
Reason: the product exactly matches the core concept-ice cream, and the desired brand-ABC, and the desired flavor-strawberry
When the search term is broader (e.g., snacks), categorical (e.g., canned beans), or looking for a brand (e.g., Pepsi), many products can be Exact. For example,
Search term: ice cream
Product name: BBB Vanilla Ice Cream
Class: Exact
Reason: The search term did not specify any attribute except for the core product—ice cream

For the candidate evaluation label 412 “substitute,” the selection criteria 444 may include a criterion that such label should be applied if the item being searched for is not available but another item would be acceptable as a substitute. Another example of selection criterion 444 may be that the core product concept may still need to be satisfied. In some embodiments, yet another example of selection criterion 444 is that the substitute item needs to fulfill the main function of the desired product. Other suitable selection criteria 444 are also possible. For example, chain-of-thoughts instruction 440 may include:
Given individual differences in peculiarity or openness for certain types of products, the substitute product may differ by one or more of the attributes (e.g. brand, flavor, form, size, color, diet, nutrition, etc.). Customers may consider the difference major or minor, but the product is functionally equivalent to the intended product.

Again, there can be one or more application examples 446. In one or more embodiments, the application examples 446 include the following:

### Example 1

Search term: ABC milk chocolate
Product name: CCC Milk Chocolate Candy Bar
Class: Substitute
Reason: the product is milk chocolate but from a different brand, hence can be a substitute when the intended brand is not available

### Example 2

Search term: Peanut Butter
Product name: ABC Almond Butter
Class: Substitute
Reason: the product can be used in place of the search term with differences in core ingredients-peanuts vs almonds

In some embodiments, the selection criteria 444 and the application examples 446 can be combined. To illustrate, using the candidate evaluation label 412 “complement” as an example, the selection criteria 444 and the application examples 446 may include one or more chain-of-thoughts analyses.
1. The product can go well with or be used together with the intended product to complete your shopping list. For example,
Search term: dried pasta
Product name: Alfredo Sauce
Class: complement
Reason: the product is a sauce that goes well with dried pasta to make pasta at home
2. The product is commonly used in the same recipe together with the intended product. For example,
Search term: turkey ham
Product name: muenster cheese
Class: complement
Reason: the product is a type of cheese that is commonly paired with turkey ham to make sandwiches
3. The product is an accessory, a component, or another item designed to be used with the intended product. For example,
Search term: birthday cake
Product name: ABC Candle Pick Set, Happy Birthday, 3 Inch High
Class: complement
Reason: The birthday candle set is designed to be used with birthday cake

In various embodiments, additional label examples 442 (such as for the labels “irrelevant” and “unjudgeable”) may also be included in the chain-of-thoughts instruction 440. Each label example 442 may include one or more selection criteria 444 and one or more application examples 446. In some embodiments, the label “irrelevant” may be used as a negative training sample for training in supervised learning. The labels “unjudgeable” may be excluded as training samples.

### Example Applications

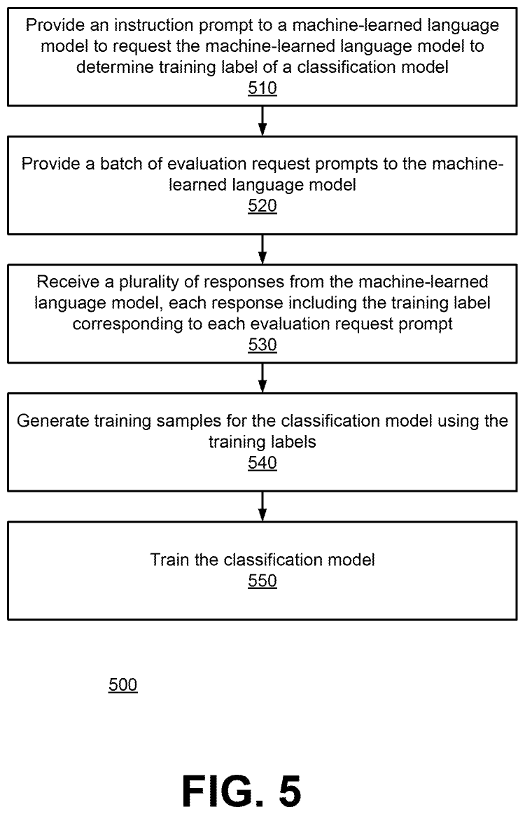

FIG. 5 is a flowchart for a process 500 for training a classification model, in accordance with some embodiments. Alternative embodiments may include more, fewer, or different steps from those illustrated in FIG. 5, and the steps may be performed in a different order from that illustrated in FIG. 5. These steps may be performed by an online system (e.g., online concierge system 140). Additionally, each of these steps may be performed automatically by the online concierge system without human intervention. The process 500 illustrated in FIG. 5 is an example of the application of the process 300 and the details of the process 300 and the instruction prompt 400 are incorporated herein.

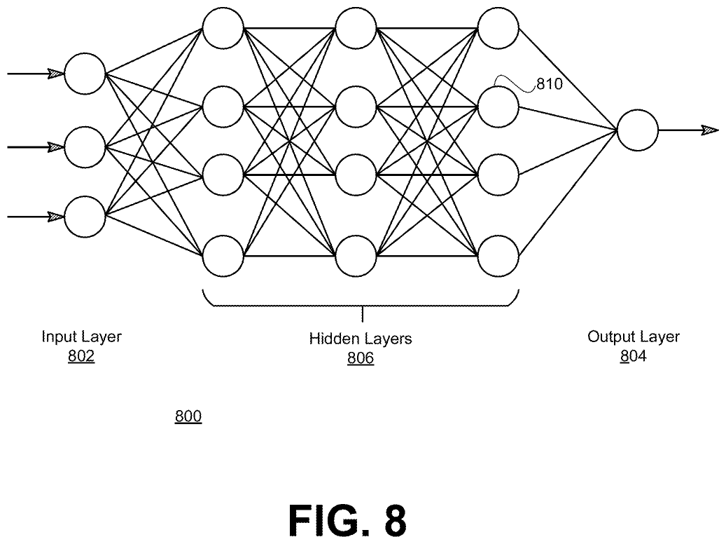

In some embodiments, the online system provides 510 an instruction prompt 400 to a machine-learned language model to request the machine-learned language model to determine training labels of training samples of a classification model. The online system provides 520 a batch of evaluation request prompts to the machine-learned language model. For example, the online system may store the historical inputs and outputs of the classification model. Each input-output pair may be used in an evaluation request prompt. The online system receives 530 a plurality of responses from the machine-learned language model. Each response includes the training label corresponding to each evaluation request prompt. The online system generates 540 training samples for the classification model using the training labels. For example, a historical input-output pair and related attributes may be stored as a training sample and the evaluation label may be stored as the corresponding training label. In some embodiments, the online system trains 550 the classification model using a supervised training technique. Further detail of training of a classification model is discussed in FIG. 8.

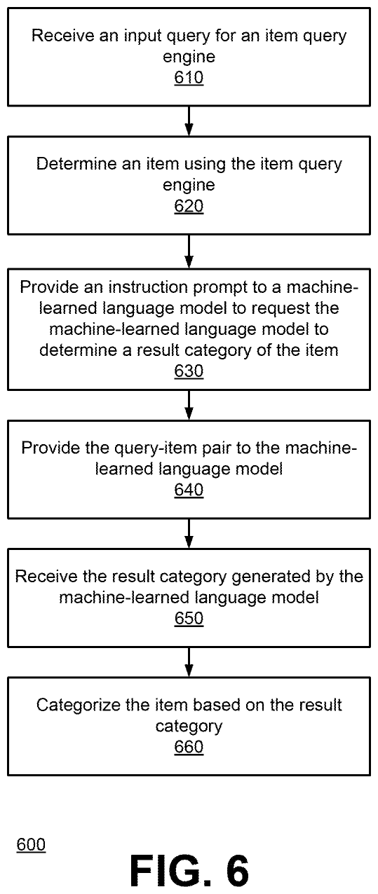

FIG. 6 is a flowchart for a process 600 for categorizing a query result, in accordance with some embodiments. Alternative embodiments may include more, fewer, or different steps from those illustrated in FIG. 6, and the steps may be performed in a different order from those illustrated in FIG. 6. These steps may be performed by an online system (e.g., online concierge system 140). Additionally, each of these steps may be performed automatically by the online concierge system without human intervention. The process 600 illustrated in FIG. 6 is an example of the application of the process 300 and the details of the process 300 and the instruction prompt 400 are incorporated herein.

The online concierge system 140 receives 610 input queries for an item query engine, which is an example of a classification model discussed in the process 300. The item query engine may be part of content presentation module 210. The input query may be provided by a user who is searching for items offered by the online concierge system 140 through a user interface provided by the online concierge system 140.

The online concierge system 140 determines 620 an item based on the input query using the item query engine. The item query engine may use any selection model and item availability model trained by the machine learning training module 230 to select an item or display a list of items offered by the online concierge system 140 based on the user query. The item(s) selected may be associated with one or more images, descriptions, and other attributes. The online concierge system 140 may store the user query, the selected item(s), the images, descriptions, and other attributes as a historical data sample. The historical input-output pair may be referred to as a query-item pair in this context.

The online concierge system 140 provides 630 an instruction prompt 400 to a machine-learned language model to request the machine-learned language model to determine a result category of an item. The instruction prompt 400 may be provided as part of the backend determination after the user provides the user query. The output of the machine-learned language model may be used to supplement the results generated by the item query engine.

The online concierge system 140 provides 640 the query-item pair to the machine-learned language model. For example, the online concierge system 140 may use the item query engine and item availability models to identify, based on the user query, one or more items that are available for selection by the end user. For each identified item, the online concierge system 140 may generate a query-item pair. One or more query-item pairs may be generated and supplied to the machine-learned language model to generate evaluation results that may classify the searched items into one or more categories.

The online concierge system 140 receives 650 the result category generated by the machine-learned language model. For example, the result categories may include exact, substitute, complement, irrelevant, and unjudgeable. The result categories may be used for sorting, grouping, filtering, and other selection of the items to be presented to the end as the result of the query.

The online concierge system 140 categorizes 660 the item based on the result category and may present the query results that are sorted by the categories. For example, the online concierge system 140 may first present the exact matches as the query result. In some cases, the online concierge system 140 may also present substitute matches, such as in situations where the exact matches are insufficient. In some cases, the online concierge system 140 may also present complement matches, such as by injecting the complement matches in appropriate locations or between exact matches as recommendations to be selected by the users along with the items being searched for.

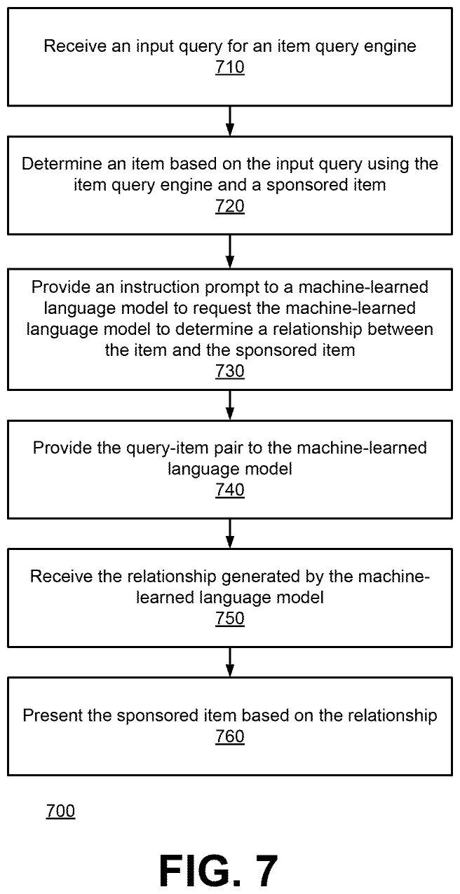

FIG. 7 is a flowchart for a process 700 for presenting the sponsored item, in accordance with some embodiments. Alternative embodiments may include more, fewer, or different steps from those illustrated in FIG. 7, and the steps may be performed in a different order from that illustrated in FIG. 7. These steps may be performed by an online system (e.g., online concierge system 140). Additionally, each of these steps may be performed automatically by the online concierge system without human intervention. The process 700 illustrated in FIG. 7 is an example of the application of the process 300 and the details of the process 300 and the instruction prompt 400 are incorporated herein.

The online concierge system 140 receives 710 an input query for an item query engine, which is an example of a classification model discussed in the process 300. The item query engine may be part of content presentation module 210. The input query may be provided by a user who is searching for items offered by the online concierge system 140 through a user interface provided by the online concierge system 140.

The online concierge system 140 determines 720 an item based on the input query using the item query engine and may further determine a sponsored item. The item query engine may use any selection model and item availability model trained by the machine learning training module 230 to select an item or display a list of items offered by the online concierge system 140 based on the user query. The item(s) selected may be associated with one or more images, descriptions, and other attributes. The online concierge system 140 may store the user query, the selected item(s), the images, descriptions, and other attributes as a historical data sample. The historical input-output pair may be referred to as a query-item pair in this context. The sponsored item may be identified by comparable attributes, similarities, bid amounts, and any other suitable sponsorship selection criteria.

The online concierge system 140 provides 730 an instruction prompt to a machine-learned language model to request the machine-learned language model to determine a relationship between the item and the sponsored item. The instruction prompt 400 may be provided as part of the backend determination after the user provides the user query. The output of the machine-learned language model may be used to supplement the results generated by the item query engine.

The online concierge system 140 provides 740 the query-item pair to the machine-learned language model. One or more query-item pairs may include one or more sponsored items to determine the relationship between the sponsored items and the items that match the search query.

The online concierge system 140 receives 750 the relationship generated by the machine-learned language model. For example, the relationship may include exact, substitute, complement, irrelevant, or unjudgeable. The relationship for a sponsored item may be exact if the sponsored item in fact matches the search query. The relationship for a sponsored item may also be a substitute for an item that is an exact match of the search query. The relationship for a sponsored item may also be a complement to an item that is going to be presented as part of the query result.

The online concierge system 140 presents 760 the sponsored items based on the relationship. For example, if the relationship is exact, the sponsored item may be sorted in a higher position in the query result such as a prominent location. If the relationship is a substitute, the sponsored item may be selected in various situations. For example, the result categories may include exact, substitute, complement, irrelevant, and unjudgeable. In some cases, the online concierge system 140 may also present complement sponsored items, such as by injecting the sponsored item in an appropriate location or between exact matches as recommendations to be selected by the users along with the items being searched for.

### Example Classification Model Training

In various embodiments, a wide variety of machine-learning techniques may be used for training a classification model using training samples that have labels automatically generated by a machine-learned language model as discussed in the process 300. Examples include different forms of supervised learning or semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various classification tasks performed by image classifiers, item selection tasks performed by an item query engine, a second language model that provides textual analysis, and other processes may apply one or more machine learning and deep learning techniques.

In various embodiments, the training techniques for a machine learning model may be supervised or semi-supervised. In supervised learning, the machine learning models may be trained with a set of training samples that are labeled. The labels may be generated by the process 300 or the process 500. For example, for a machine learning model trained to select items, the training samples may include query-item pairs, attributes, images, descriptions, and other metadata. The labels for each training sample may be binary or multi-class. In training a machine learning model for item selection, the training labels may include a positive label that indicates the query result is satisfactory (e.g., finding exact or substitute items) and a negative label that indicates the query result is poor (e.g., finding results that are irrelevant). In some embodiments, the training labels may also be multi-class such as using the various levels of relevancy of the result, such as exact, substitute, complement, irrelevant, unjudgeable, etc.

By way of example, the training set may include multiple past records of outputs of a classification model with labels that are automatically generated by the machine-learned language model. Each training sample in the training set may correspond to a past and the corresponding outcome may serve as the label for the sample. A training sample may be represented as a feature vector that includes multiple dimensions. Each dimension may include data of a feature, which may be a quantized value of an attribute that describes the past record. For example, in a machine learning model that is used to select the item, the features in a feature vector may include query-item pairs, attributes, images, descriptions and other metadata, etc. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in supervised learning, the objective function may correspond to whether the predicted label matches the training label generated by the machine-learned language model. In various embodiments, the error rate may be measured as cross-entropy loss, L1 loss (e.g., the sum of absolute differences between the predicted values and the actual value), and L2 loss (e.g., the sum of squared distances).

Referring to FIG. 8, the structure of an example neural network is illustrated, in accordance with some embodiments. The neural network 800 may receive an input and generate an output. The input may be the feature vector of a training sample in the training process and the feature vector of an actual case when the neural network is making an inference. The output may be the prediction, classification, or another determination performed by the neural network. The neural network 800 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of a convolutional layer and a pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one or more embodiments, one or more custom layers may also be presented for the generation of a specific format of the output. For example, a custom layer may be used for image segmentation for labeling pixels of an image input with different segment labels.

The order of layers and the number of layers of the neural network 800 may vary in different embodiments. In various embodiments, a neural network 800 includes one or more layers 802, 804, and 806, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 810, kernels and/or coefficients. Training of a neural network, such as the NN 800, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 810. The computing device, in forward propagation, may use the machine learning model to generate predicted labels. The computing device may compare the predicted labels with the labels generated by the machine-learned language model. The computing device may adjust, in a backpropagation, the weights of the machine learning model based on the comparison. The computing device backpropagates one or more error terms obtained from one or more loss functions to update a set of parameters of the machine learning model. The backpropagation may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing a categorization task or another suitable task for which the model is trained.

In various embodiments, the training samples described above may be refined and continue to re-train the model, which is the model's ability to perform the inference tasks. In some embodiments, this training and re-training processes may repeat, which results in a computer system that continues to improve its functionality through the use-retraining cycle. For example, after the model is trained, multiple rounds of re-training may be performed. The process may include periodically retraining the machine learning model. The periodic retraining may include obtaining an additional set of training data, such as through other sources, by usage of users, and by using the trained machine learning model to generate additional samples. The additional set of training data and later retraining may be based on updated data describing updated parameters in training samples. The process may also include applying the additional set of training data to the machine learning model and adjusting the parameters of the machine learning model based on the application of the additional set of training data to the machine learning model. The additional set of training data may include any features and/or characteristics that are mentioned above.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually, separately, or distributively, comprise instructions that, when executed by one or more processors, cause the one or more processors to perform, individually, separately, or distributively, the steps of the instructions stored on the one or more computer-readable media. Similarly, a processor comprises one or more processors or processing units that, individually, separately, or distributively, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising, at an online system comprising one or more processors and one or more computer-readable media:
providing an instruction prompt to a machine-learned language model, the instruction prompt comprising (1) an instruction for the machine-learned language model to generate an evaluation label of a training sample of a classification model, and (2) a textual format related to how data is arranged, wherein the evaluation label is to be used as a training label for the training sample in a supervised training of the classification model;
providing a batch of evaluation request prompts to the machine-learned language model, each evaluation request prompt comprising data that is at least partially arranged in the textual format described in the instruction prompt;
receiving a plurality of responses from the machine-learned language model, each response comprising the evaluation label corresponding to each evaluation request prompt; and
storing at least evaluation labels and the data in the evaluation request prompts as training samples for the supervised training of the classification model.

2. The method of claim 1, wherein providing the instruction prompt to the machine-learned language model comprises:
specifying an input textual format of an input that the machine-learned language model is to receive;
specifying an output textual format of an output that the machine-learned language model is to generate; and
including a chain-of-thoughts instruction for the machine-learned language model to follow in performing evaluation, the chain-of-thoughts instruction including an explanation for each evaluation label on how the training sample should be classified to the evaluation label.

3. The method of claim 1, wherein providing the instruction prompt to the machine-learned language model comprises:
providing a multimodal input example that follows the textual format, the multimodal input example including an input to the classification model, an output of the classification model, attribute data retrieved from a database of the online system, and an image; and
specifying an output format that includes the evaluation label and a reason for assigning the evaluation label.

4. The method of claim 1, wherein providing the instruction prompt to the machine-learned language model comprises:
specifying a set of candidate evaluation labels in the instruction for the machine-learned language model to generate the evaluation label;
providing an example for each candidate evaluation label on one or more selection criteria for the candidate evaluation label; and
providing a chain-of-thoughts instruction in applying the one or more selection criteria for each candidate evaluation label.

5. The method of claim 1, wherein the instruction prompt further comprises one or more of:
a set of candidate evaluation labels;
an example of input of the machine-learned language model, the input being in the textual format;
an example of output of the machine-learned language model;
a chain-of-thought instruction; or
an explanation for selecting each candidate evaluation label.

6. The method of claim 1, wherein the classification model is a search engine for an item based on a search query, and wherein providing the instruction prompt to the machine-learned language model comprises:
including a first instruction for the machine-learned language model to identify a search intent from the search query;
including a second instruction for the machine-learned language model to identify one or more attributes of the item returned by the search engine; and
providing one or more examples to the machine-learned language model on how the evaluation label is assigned based on comparing the one or more attributes of the item to the search intent.

7. The method of claim 1, wherein providing the batch of evaluation request prompts to the machine-learned language model comprises:
retrieving historical inputs and historical outputs of the classification model that are stored in a database;
formatting the historical inputs and historical outputs according to the textual format that is provided in the instruction prompt; and
generating the batch of evaluation request prompts, each evaluation request prompt includes the historical inputs and historical outputs.

8. The method of claim 1, further comprising training the classification model, wherein training the classification model comprises:
retrieving the training samples of the classification model, the training samples each comprising the evaluation label generated by the machine-learned language model;
applying, in forward propagation, the classification model to the training samples to generate predicted labels;
comparing the predicted labels to the evaluation label generated by the machine-learned language model; and
adjusting, in backpropagation, one or more parameters of the machine-learned language model based on the comparing.

9. The method of claim 1, further comprising:
receiving a query for the classification model;
identifying, by the classification model, an item based on the query;
applying the machine-learned language model to generate the evaluation label for the item; and
providing the evaluation label as a classification in response to the query.

10. The method of claim 1, further comprising:
receiving a query for the classification model;
identifying, by the classification model, a plurality of items based on the query;
applying the machine-learned language model to generate evaluation labels for the plurality of items; and
selecting, based on the evaluation labels, one of the plurality of items as a sponsored item to be displayed as a response to the query.

11. A computer program product comprising one or more non-transitory computer-readable storage media configured to store code comprising executable code instructions, wherein the executable code instructions, when executed, cause one or more processors to:
provide an instruction prompt to a machine-learned language model, the instruction prompt comprising (1) an instruction for the machine-learned language model to generate an evaluation label of a training sample of a classification model and (2) a textual format related to how data is arranged, wherein the evaluation label is to be used as a training label for the training sample in a supervised training of the classification model;
provide a batch of evaluation request prompts to the machine-learned language model, each evaluation request prompt comprising data that is at least partially arranged in the textual format described in the instruction prompt;
receive a plurality of responses from the machine-learned language model, each response comprising the evaluation label corresponding to each evaluation request prompt; and
store at least evaluation labels and the data in the evaluation request prompts as training samples for the supervised training of the classification model.

12. The computer program product of claim 11, wherein the executable code instruction to provide the instruction prompt to the machine-learned language model comprises instructions to:
specify an input textual format of an input that the machine-learned language model is to receive;
specify an output textual format of an output that the machine-learned language model is to generate; and
include a chain-of-thoughts instruction for the machine-learned language model to follow in performing evaluation, the chain-of-thoughts instruction include an explanation for each evaluation label on how the training sample should be classified to the evaluation label.

13. The computer program product of claim 11, wherein the executable code instruction to provide the instruction prompt to the machine-learned language model comprises instructions to:
provide a multimodal input example that follows the textual format, the multimodal input example include an input to the classification model, an output of the classification model, attribute data retrieved from a database of an online system, and an image; and
specify an output format that includes the evaluation label and a reason for assigning the evaluation label.

14. The computer program product of claim 11, wherein the executable code instruction to provide the instruction prompt to the machine-learned language model comprises instructions to:
specify a set of candidate evaluation labels in the instruction for the machine-learned language model to generate the evaluation label;
provide an example for each candidate evaluation label on one or more selection criteria for the candidate evaluation label; and
provide a chain-of-thoughts instruction in applying the one or more selection criteria for each candidate evaluation label.

15. The computer program product of claim 11, wherein the instruction prompt further comprises one or more of:
a set of candidate evaluation labels;
an example of input of the machine-learned language model, the input being in the textual format;
an example of output of the machine-learned language model;
a chain-of-thought instruction; or
an explanation for selecting each candidate evaluation label.

16. The computer program product of claim 11, wherein the instruction to the classification model is a search engine for an item based on a search query, and wherein the executable code instruction to provide the instruction prompt to the machine-learned language model comprises instructions to:
include a first instruction for the machine-learned language model to identify a search intent from the search query;
include a second instruction for the machine-learned language model to identify one or more attributes of the item returned by the search engine; and
provide one or more examples to the machine-learned language model on how the evaluation label is assigned based on compare the one or more attributes of the item to the search intent.

17. The computer program product of claim 11, wherein the executable code instruction to provide the batch of evaluation request prompts to the machine-learned language model comprises instructions to:
retrieve historical inputs and historical outputs of the classification model that are stored in a database;
format the historical inputs and historical outputs according to the textual format that is provided in the instruction prompt; and
generate the batch of evaluation request prompts, each evaluation request prompt includes the historical inputs and historical outputs.

18. The computer program product of claim 11, wherein the executable code instructions, when executed, further cause the one or more processors to train the classification model, wherein the executable code instruction to train the classification model comprises instructions to:
retrieve the training samples of the classification model, the training samples each comprising the evaluation label generated by the machine-learned language model;
apply, in forward propagation, the classification model to the training samples to generate predicted labels;
compare the predicted labels to the evaluation label generated by the machine-learned language model; and
adjust, in backpropagation, one or more parameters of the machine-learned language model based on the comparing.

19. The computer program product of claim 11, wherein the executable code instructions, when executed, further cause the one or more processors to:
receive a query for the classification model;
identify, by the classification model, an item based on the query;
applying the machine-learned language model to generate the evaluation label for the item; and
provide the evaluation label as a classification in response to the query.

20. A system comprising:
one or more processors; and
one or more non-transitory computer-readable storage media configured to store code comprising executable code instructions, wherein the executable code instructions, when executed, cause the one or more processors to:
provide an instruction prompt to a machine-learned language model, the instruction prompt comprising (1) an instruction for the machine-learned language model to generate an evaluation label of a training sample of a classification model and (2) a textual format related to how data is arranged, wherein the evaluation label is to be used as a training label for the training sample in a supervised training of the classification model;
provide a batch of evaluation request prompts to the machine-learned language model, each evaluation request prompt comprising data that is at least partially arranged in the textual format described in the instruction prompt;
receive a plurality of responses from the machine-learned language model, each response comprising the evaluation label corresponding to each evaluation request prompt; and
store at least evaluation labels and the data in the evaluation request prompts as training samples for the supervised training of the classification model.
